(19) United States
(12) Patent Application Publication
(10) Pub. No.: US 2019/0201273 A1
(43) Pub. Date: Jul. 4, 2019

(54) ROBOTIC UPPER LIMB REHABILITATION DEVICE

(71) Applicant: QATAR FOUNDATION FOR EDUCATION, SCIENCE, AND COMMUNITY DEVELOPMENT, DOHA (QA)

(72) Inventors: RANA SOLTANI-ZARRIN, COLLEGE STATION, TX (US); AMIN ZEIAEE, COLLEGE STATION, TX (US); REZA LANGARI, COLLEGE STATION, TX (US); REZA TAFRESHI, DOHA (QA)

(21) Appl. No.: 16/298,777

(22) Filed: Mar. 11, 2019

Related U.S. Application Data
(63) Continuation-in-part of application No. PCT/US2017/050922, filed on Sep. 11, 2017.
(60) Provisional application No. 62/385,941, filed on Sep. 9, 2016.
(60) Provisional application No. 62/510,224, filed on May 23, 2017.

(51) Int. Cl. A61H 1/02; B25J 9/00

(52) U.S. Cl. CPC A61H 1/0277; B25J 9/0006; A61H 1/0281; A61H 1/0285; A61H 2201/5061; A61H 2201/123; A61H 2201/165; A61H 2205/06; A61H 2201/1659; A61H 2201/0103

(57) ABSTRACT

The robotic upper limb rehabilitation device assists in rehabilitation of an upper limb of a human patient recovering from a stroke or the like. The device is an exoskeleton having an articulated shoulder assembly having five degrees of freedom, including at least two degrees of freedom simulating inner shoulder movement. An upper arm member is pivotally attached to the shoulder assembly, and a forearm assembly is pivotally attached to the upper arm member. An inflatable handgrip is pivotally attached to the forearm assembly. A robotic control unit receives signals from sensors and is configured to activate actuators attached to the exoskeleton to assist upper limb movement when required, or to permit the exoskeleton to conform to upper limb movement when no assistance is required.

### CROSS-REFERENCE TO RELATED APPLICATION

This application is a continuation-in-part of International Application PCT/US2017/050922, filed on Sep. 11, 2017, which claims priority to U.S. provisional patent application Ser. No. 62/385,941, filed on Sep. 9, 2016 and U.S. provisional patent application Ser. No. 62/510,224, filed on May 23, 2017.

### BACKGROUND

### 1. Field

The disclosure of the present patent application relates to driven exoskeletons for limb rehabilitation for stroke patients and the like, and particularly to a robotic upper limb rehabilitation device including multiple points of articulation driven under response to motion feedback signals.

### 2. Description of the Related Art

Following a stroke, once the patient is medically stable, the primary focus of the patient's recovery is directed towards rehabilitation. Current therapies rely heavily on physical and occupational therapists. The costs associated with such therapy, along with limitations on the number of available professional staff and the labor intensive nature of rehabilitation therapy, hinder the implementation of high intensity and long therapy sessions for stroke patients. Since the intensity and length of rehabilitative therapy are known to impact the therapy's effectiveness, it is obviously important to be able to supplement the therapy sessions provided by physical and occupational therapists. Due to the growing number of elderly patients, and since most stroke cases occur in people over the age of 65, there will be a tremendous need for rehabilitation in the near future. Current manual therapy techniques are not sufficient to address this growing need.

The inherent capabilities of robotic systems in producing high intensity, repeatable and precisely controllable motions make them a desirable candidate for rehabilitation purposes. Robotic exoskeletons, in particular, have been shown to be effective in providing automated therapy for rehabilitation of paretic limbs. However, despite the advantages of robotic exoskeletons, there are major challenges associated with their kinematic compatibility with the human arm, thus making the design of prosthetic devices challenging. In addition to kinematic challenges, actuation and control of exoskeletons is also challenging. Thus, a robotic upper limb rehabilitation device solving the aforementioned problems is desired.

### SUMMARY

The robotic upper limb rehabilitation device is an articulated exoskeleton adapted for attachment to an upper limb of a human patient. The upper limb rehabilitation device includes an articulated shoulder assembly, mounted on an external stand that supports the weight of the device, an upper arm member pivotally attached to the shoulder assembly, a forearm assembly pivotally attached to the upper arm member, and an inflatable hand grip pivotally attached to the forearm assembly. A plurality of rotational actuators and a plurality of sensors are further provided for interconnection with a robotic control unit. In use, the robotic control unit is configured for permitting the robotic upper limb rehabilitation device to conform to movement of a user's upper limb upon receiving signals from the plurality of sensors indicating normal movement of the user's upper limb. Further, the robotic control unit is configured for activating the plurality of rotational actuators to provide articulated movement of the robotic upper limb rehabilitation device to assist movement of the user's upper limb upon receiving signals from the sensors indicating impaired movement of the user's upper limb.

These and other features of the robotic upper limb rehabilitation device will become readily apparent upon further review of the following specification and drawings.

### BRIEF DESCRIPTION OF THE DRAWINGS

FIG. 1 is a perspective view of a kinematic structure of a robotic upper limb rehabilitation device.

FIG. 2 is a perspective view of the robotic upper limb rehabilitation device.

FIG. 3 is a block diagram showing a control system of the robotic upper limb rehabilitation device.

FIG. 4 is a partially cut-away perspective view of a rotational actuator of the robotic upper limb rehabilitation device.

FIG. 5 is a plan view of the robotic upper limb rehabilitation device with Denavit-Hartenberg physical parameters and coordinates overlaid thereon.

FIG. 6 is a graph showing motion capture data for range of motion analysis of the robotic upper limb rehabilitation device.

FIG. 7 is a three-dimensional graph comparing workspaces of the robotic upper limb rehabilitation device against those of a healthy human arm during performance of activities of daily living (ADL) tasks.

Similar reference characters denote corresponding features consistently throughout the attached drawings.

### DETAILED DESCRIPTION OF THE PREFERRED EMBODIMENTS

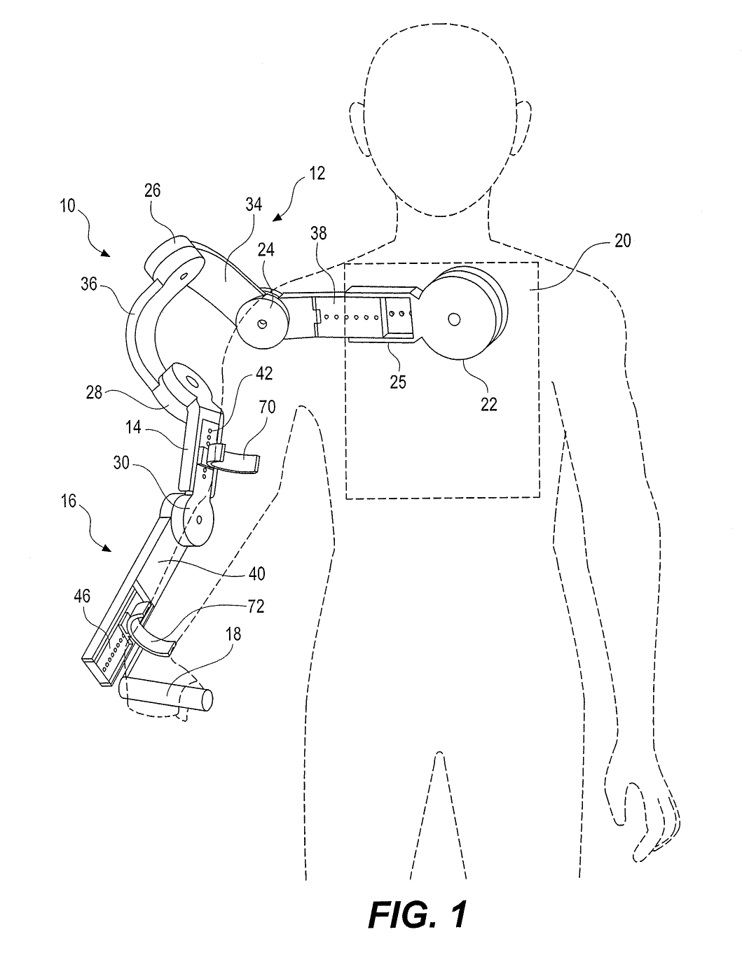

The robotic upper limb rehabilitation device (RULRD) 10 is an articulated exoskeleton adapted for attachment to an upper limb of a human patient. As best shown in FIG. 1, the upper limb rehabilitation device 10 includes an articulated shoulder assembly 12, an upper arm member 14 pivotally attached to the shoulder assembly 12, a forearm assembly 16 pivotally attached to the upper arm member 14, and an inflatable hand grip 18 pivotally attached to the forearm assembly 16. The robotic upper limb rehabilitation device 10 assists in rehabilitation of an upper limb of a human patient recovering from a stroke or the like. The articulated shoulder assembly 12 has five degrees of freedom, including at least two degrees of freedom simulating inner shoulder movement. Overall, the robotic upper limb rehabilitation device 10 has eight degrees of freedom, supporting the motion of the shoulder girdle, the glenohumeral (GH) joint, the elbow and the wrist. Out of the eight degrees of freedom, six degrees of freedom are active while the other two are passive. An active degree of freedom is used for assisting flexion/extension of the elbow, and the five active degrees of freedom noted above are used in the design of the articulated shoulder assembly 12 to improve the ergonomics of the overall device 10.

The two passive degrees of freedom of the wrist allow the pronation/supination, and flexion/extension, of the wrist. The five degrees of freedom provided for the articulated shoulder assembly 12 support the motion of the GH joint center on the body frontal plane. Additionally, as will be described in further detail below, the device 10 includes a back-drivable prismatic joint 25 and a pair of linearly adjustable sliding mechanisms 42, 46 having selectively adjustable lengths, thus allowing the device to accommodate a wide spectrum of different users.

It is important to note that the first rotational actuator 22 is adapted for attachment to an external support or stand, which supports the weight of the device. Further, it should be noted that neither prismatic joint 25 nor member 38 contact the body. The rotational actuator 22 and the prismatic joint 25 are part of the articulated shoulder assembly 12 for supporting the motion of the inner shoulder. The role of the back-drivable prismatic joint 25) is adding controllable compliance to the inner shoulder mechanism to enable automatic adjustment of the shoulder center (GH) motion during the operation of the device, since it is known that the path of GH joint is not the same for all patients. In FIG. 1, numeral 20 generally represents a vest or other type of garment or support worn by the user. This vest 20 is typically releasably fixed to a wheelchair or the like. When worn, the first rotational actuator 22 should be positioned substantially centrally with respect to the patient's back

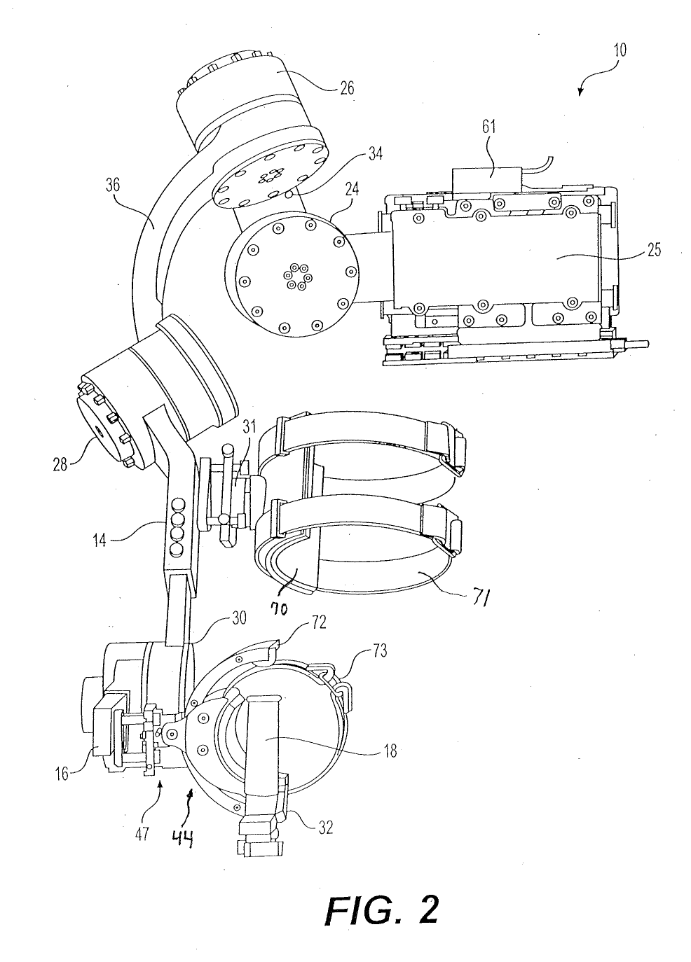

A second rotational actuator 24 is further connected to the member 38, as shown in FIGS. 1 and 2, such that the member 38 extends between the second rotational actuator 24 and the prismatic joint 25. It should be understood that the axis of rotation of joints 22 and 24 does not have to be parallel, and that there may be an angle of approximately 10° to 20° between the plane of the rotary joint 24 and the plane of the member 38. The prismatic joint 25 may incorporate a pair of linear encoders 61, which are in communication with controller 50 (as will be described in greater detail below).

A first arcuate shoulder member 34 is secured to, and extends between, the second rotational actuator 24 and a third rotational actuator 26. The angular range of the arcuate shoulder member 34 may be between approximately 50° and approximately 75°. As an example, the angular span may be approximately 60°. A second arcuate shoulder member 36 is secured to, and extends between, the third rotational actuator 26 and a fourth rotational actuator 28. The angular range of the arcuate shoulder member 36 may be between approximately 80° and 100°. For example, the angular range may be approximately 90°. The first and second arcuate shoulder members 34, 36 hook the shoulder assembly 12 over the patient's shoulder.

As shown, the fourth rotational actuator 28 is rotatively coupled to the upper arm member 14. The shoulder assembly 12 allows for rotation of upper arm member 14 along the three axes of 24, 26 and 28, replicating a spherical joint. The respective radii of the first and second arcuate shoulder members 34, 36 may allow for the intersection of all three axes of rotation at a single point, which is equivalent to the center of the spherical joint. The linkage of upper arm member 14 to fourth rotational actuator 28 is preferably angled, as shown in FIG. 1, at approximately 120° to 150°. For example, the angle may be approximately 125°. The first physical interaction point between the exoskeleton and the patient's arm is the upper arm brace 70, which is located on this linkage. The angle in the geometry of this linkage decreases the gap between the upper arm and the corresponding link in the exoskeleton, which, in turn, results in a more stable interface between the device 10 and the user's arm.

All of the linkages of the device, including member 38, first arcuate shoulder member 34, second arcuate shoulder member 36, upper arm member 14, upper arm adjustable member 42, frontal arm member 16 including the linkage 40 and the frontal arm adjustable member 46, and each of the other structural components of the device 10, may be hollow, allowing the interiors of each structural component to be used for passage of wires, cables and the like.

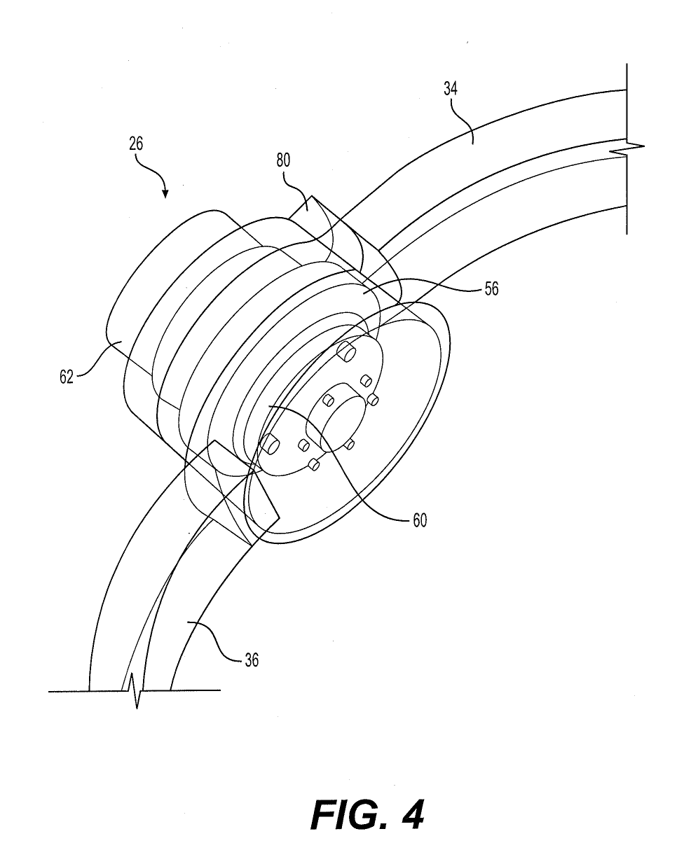

It should be understood that any suitable type of rotational actuators may be used. Using the third rotational actuator 26 as an example, FIG. 4 illustrates an exemplary arrangement for each of the rotational actuators. As shown, a motor 62, and a rotational encoder 60 are mounted within a housing 80. Encoder 60 measures rotational motion and sends feedback signals to the robotic control unit 50. It should be understood that although shown only for third rotational actuator 26, the arrangement illustrated in FIG. 4 may be applied to each of the other rotational actuators of the robotic upper limb rehabilitation device 10. Preferably, the motors 62 are coupled with zero backlash gearing systems 56, such as the strain wave gearing systems manufactured by Harmonic Drive® LLC of Massachusetts, to increase the output torque of the motors 62 to the level required for rehabilitation purposes.

As shown in FIGS. 1 and 2, a fifth rotational actuator 30 is further provided, with the forearm assembly 16 including a forearm member 40 connected to fifth rotational actuator 30. The fifth rotational actuator 30 is also connected to the upper arm member 14, as shown, by a selectively adjustable first linearly adjustable connector 42. An upper arm brace 70 may be secured to the upper arm member 14 via a six-axis force/torque sensor 31, for releasably receiving an upper arm of the user. A forearm support 72 is connected to the forearm member 40 by a selectively adjustable second linearly adjustable connector 46. The connection between forearm support 72 and the second linearly adjustable connector 46 is via a six-axis force/torque sensor 47. A circular rail is installed on the forearm support 72, on which the gripper assembly 44 can slide to enable pronation and supination of the forearm. The gripper assembly 44 includes a forearm brace 32 and the inflatable hand grip 18, which is pivotally attached to the forearm brace 32. The forearm support 72 is provided for releasably receiving a forearm of the user. The upper arm brace 70 and the forearm support 72 each preferably include inflatable cushions for the comfort of the user and adjustable straps 71 and 73 for securing the user limb onto the device. Preferably, each of the first, second, third, fourth and fifth rotational actuators 22, 24, 26, 28, 30 include a pair of rotational encoders, one being an absolute encoder 60 and one being an incremental encoder. The incremental encoders are preferably built into the corresponding motors 62.

Flexion and extension of the elbow is supported by the active joint connecting the upper arm member 14 to forearm assembly 16, i.e., fifth rotational actuator 30. Adjustability of first linearly adjustable connector 42 and second linearly adjustable connector 46 allows for a close alignment of the exoskeleton joint to the patient's elbow. Pronation and supination of the user's forearm is realized by a passive degree of freedom provided by a passive rotational joint, which is realized by sliding of the forearm brace 32 over the circular rail installed on the forearm support 72. The pivotal connection of the inflatable gripper 18 to the forearm brace 32 enables the flexion/extension motions of the wrist as the eighth degree of freedom. It should be understood that the passive degrees of freedom in the design of the wrist portion can be replaced with actuated degrees of freedom to provide active assistance.

Adjustable straps 71 for the upper arm are provided to secure the device to the user's arm, such that the user's upper arm and the device upper arm member 14 are always parallel. Patients without sufficient grip strength may have an unstable interaction with the device 10 via hand grip 18. Thus, forearm straps 73 should secure the wrist of such users to the device, ensuring a continuous contact with the patient's hand. The hand grip 18 is preferably inflatable for two reasons. First, the gripping strength of the user may be measured by measuring the pressure of the fluid within the inflatable tube forming the inflatable grip; and second, the inflation of the tube can be used for training the hand and fingers of the patient, specifically by being able to simulate objects with different sizes.

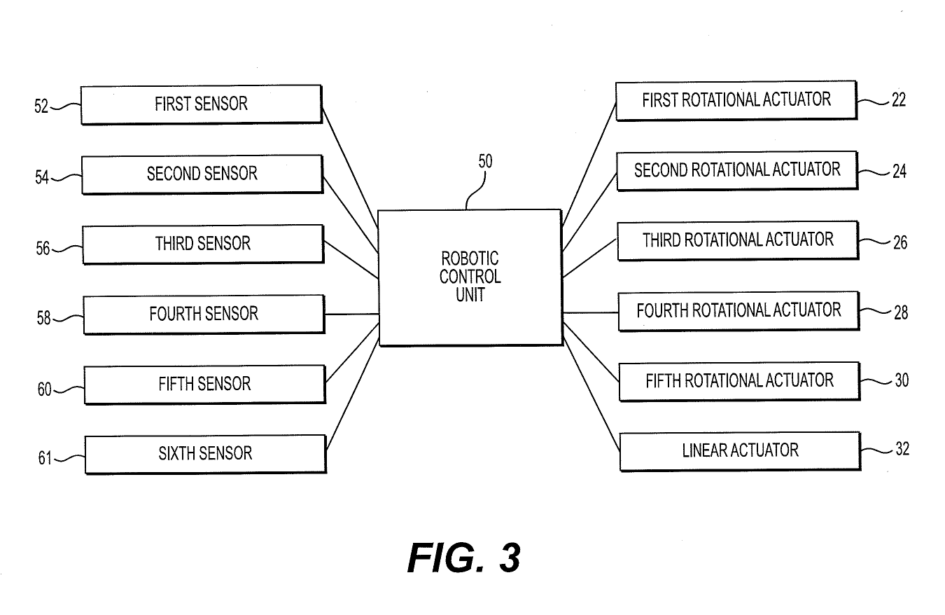

As noted above, and as illustrated in FIG. 3, the first, second, third, fourth and fifth rotational actuators 22, 24, 26, 28, 30, and a corresponding set of first, second, third, fourth, fifth and sixth sensors 52, 54, 56, 58, 60, along with the linear encoders 61 and force sensors 31, 47, are preferably in communication with a robotic control unit 50. In use, the robotic control unit 50 is configured to permit the robotic upper limb rehabilitation device 10 to conform to movement of a user's upper limb upon receiving signals from the plurality of sensors 52, 54, 56, 58, 60, 61, 31, 47, indicating normal movement of the user's upper limb. Further, the robotic control unit 50 is configured to activate the plurality of actuators 22, 24, 25, 26, 28, 30 to provide articulated movement of the robotic upper limb rehabilitation device 10 to assist movement of the user's upper limb upon receiving signals from the sensors 52, 54, 56, 58, 60, 61, 31, 47, indicating impaired movement of the user's upper limb.

It should be understood that the robotic control unit 50 may be any suitable type of controller, processor, computer, programmable logic controller or the like. Here, the first, second, third, fourth and fifth sensors 52, 54, 56, 58, 60 are preferably in the form of the encoders mounted within each active rotational joint, as described above. In addition to control of the actuators 22, 24, 25, 26, 28, 30, it should be understood that first linearly adjustable connector 42 and second linearly adjustable connector 46 may also be driven under the control of robotic control unit 50, particularly through the usage of suitable linear actuators or the like to enable automatic adjustment of the robot to patients with different sizes.

As discussed above, the shoulder assembly 12 has five degrees of freedom, which support the motion of the user's GH joint, as well as the user's shoulder girdle. Each of these five degrees of freedom are associated with the plurality of actuators 22, 24, 25 26, 28. The group of bones constituting the shoulder girdle undergo a very complicated motion with the elevation of the arm, the net contribution of which is GH joint center displacement in three-dimensional space. Thus, the robotic upper limb rehabilitation device 10 uses two active degrees of freedom (provided by first rotational actuator 22 and prismatic actuator 25) to support the motion of the GH joint center in the frontal plane of the human body. The motion of the GH joint center is negligible in the dorsal/ventral directions and supporting this motion is not practically feasible. Using two degrees of freedom allows effective tracking of the path of the GH joint center on the frontal plane, without the necessity of approximation with a circular curve. Further, as noted above, automatic adjustment of the length of the inner shoulder link, via back-drivability of the prismatic joint 25, allows for usage by a variety of patients and makes the system inherently safe against the possibility of shoulder dislocation due to misalignment of robot/user joint axes. It should be noted that the adjustment is not solely for accommodating different patient sizes, but also to allow un-modeled and user-specific displacement profile of the GH center during motion. This joint is driven under the control of robotic control unit 50, particularly through the usage of back-drivable linear actuators.

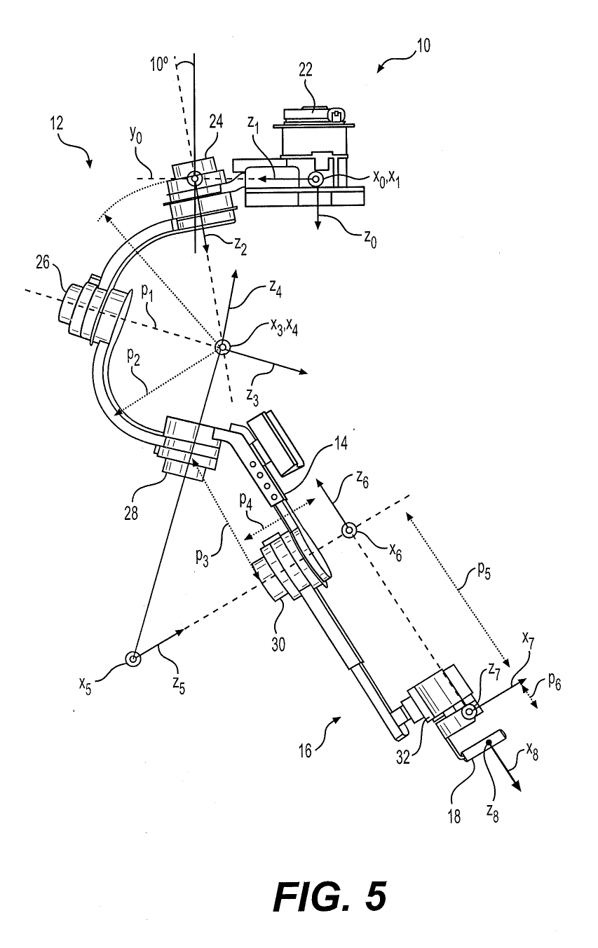

Kinematics of the robotic upper limb rehabilitation device 10 is modeled using the Denavit-Hartenberg (DH) convention. FIG. 5 and Table 1, respectively, show the assignment of the Denavit-Hartenberg coordinate systems and parameters in the fully extended configuration of device 10. Physical parameters p1, p2, p3, p4, p5 and p6 are in FIG. 5. Among this set of parameters, p3 and p5 can be changed by adjusting the length of the corresponding links based on the dimensions of patient body, i.e., by respective adjustment of first linearly adjustable connector 42 and second linearly adjustable connector 46 dependent upon the patient's particular physical dimensions.

TABLE 1
Denavit-Hartenberg (DH) Parameters

| | DH Parameters | | | |
|---|---|---|---|---|
| Link | aᵢ | aᵢ | dᵢ | θᵢ |
| 1 | 0 | −90° | 0 | θ₁* |
| 2 | 0 | 100° | d₂* | 0 |
| 3 | 0 | 70° | p₁ | θ₃* |
| 4 | 0 | 90° | 0 | θ₄* |
| 5 | 0 | −35° | $- {p}_{2} - ( \frac{{p}_{3}}{cos 55 °} )$ | θ₅* |
| 6 | 0 | 90° | p₃ tan(55°) + p₄ | θ₆* |
| 7 | 0 | −90° | −p₅ | θ₇* |
| 8 | p₆ | 0° | 0 | θ₈* |

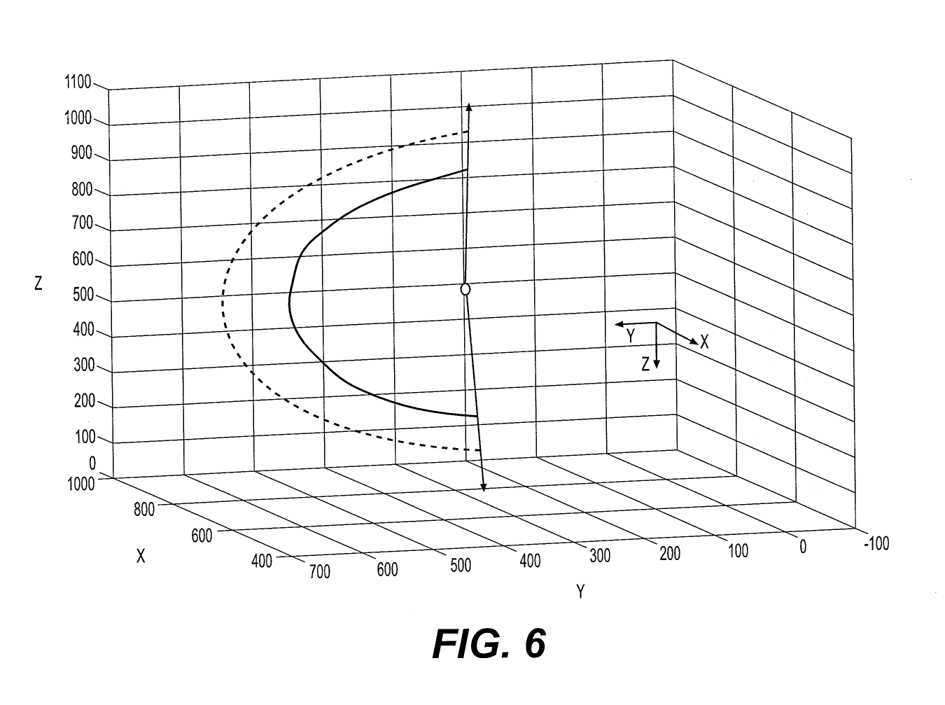

Compatibility of the robotic upper limb rehabilitation device 10 with the natural motion of the human arm was verified by studying the supported range of motion experimentally. The robotic upper limb rehabilitation device 10 was 3D printed in full scale and was adjusted and tested on a human subject. Since the axes of rotation of the shoulder assembly 12 are not biologic axes of rotation of the arm, studying their range of motion is not conclusive for determining the device's supported range of motion. Thus, the range of motion of the robotic upper limb rehabilitation device 10 was found using a reflective motion capture system. Two reflectors were placed on each segment of robotic upper limb rehabilitation device 10, and three reflectors were placed on the device base to define the body coordinate system. By tracking the position of the two markers, the orientation of the robotic upper limb rehabilitation device 10 was determined with respect to the body frame, and the achievable range of motion was calculated by manual actuation of the exoskeleton joints. FIG. 6 shows an example of the captured data where the dashed and dotted curves show the respective path of the reflectors, and the arrows illustrate the initial and final orientations of the arm.

Table 2 below compares the range of motion (ROM) of the robotic upper limb rehabilitation device 10 and the ROM of a healthy human arm, along with the ROM required for performing activities of daily living (ADL). It is important to note that the full range of motion supported by the robotic upper limb rehabilitation device 10 is larger than the values reported in Table 2. The ROM values in Table 2 that are specified by an asterisk are the values that are limited by the ROM of a healthy human arm. Table 2 shows values for shoulder flexion/extension (Sh-Fl), abduction/adduction (Sh-Ab), horizontal abduction/adduction (Sh-HA), elbow flexion/extension (Elb-Fl), lower arm pronation/supination (Arm-Pr) and wrist flexion/extension (Wr-Fl). The range of motion for the internal/external rotation of shoulder is not included, since it depends on the elevation and horizontal abduction of the arm.

TABLE 2
Range of Motion (°)

| | | | Sh- | | | |
|---|---|---|---|---|---|---|
| | Shoulder | Shoulder | Horizontal | Elbow | Wrist | Wrist |
| | Flexion | Abduction | Abduction | Flexion | Pronation | Flexion |
| Device 10 | 180 | 180* | 140 | 150* | 155 | 160* |
| ADL Healthy | 110 | 100 | 130 | 150 | 150 | 115 |
| Human Arm | 180 | 180 | 180 | 150 | 180 | 160 |

As Table 2 shows, the device range of motion is very close to that of a healthy human arm and fully covers the range of motion needed for ADL tasks. To identify the full work space of the device, limitations on the range of rotation for each joint of device 10 were found. The limit values are due to the physical interference of the device with itself and the physical stop integrated into the device's elbow design to avoid hyperextension of the elbow and ensure safety of device usage. The joint rotation limit values are shown in Table 3 below. In Table 3, the † symbol indicates full stroke of the linear motor. The asterisk values indicate limitation due to the physical stop.

TABLE 3
Joint Rotation Limits (radians)

| | θ₁ | d₂^{†} | θ₃ | θ₄ | θ₅ | θ₆ | θ₇ | θ₈ |
|---|---|---|---|---|---|---|---|---|
| Minimum | −π | dₘᵢₙ | −π | −π | $- \frac{3 π}{4}$ | $- \frac{7 π}{18}$ | $- \frac{3 π}{4}$ | $- \frac{3 π}{2}$ |
| Maximum | π | dₘₐₓ | π | π | $\frac{3 π}{4}$ | 0* | $\frac{π}{4}$ | $\frac{3 π}{2}$ |

The full workspace of the robotic upper limb rehabilitation device 10 as a robotic manipulator is found by substituting the joint range values into the forward kinematics of the exoskeleton. Table 4 below shows the values of the physical parameters of device 10 used by the forward kinematics equations for simulating the workspace.

TABLE 4
Parameters Used in the DH Formulation

Parameter

| | p₁ | p₂ | p₃ | p₄ | p₅ | p₆ |
|---|---|---|---|---|---|---|
| Unit (cm) | 7.735 | 24.00 | 8.974 | 8.974 | 29.3 | 6.23 |

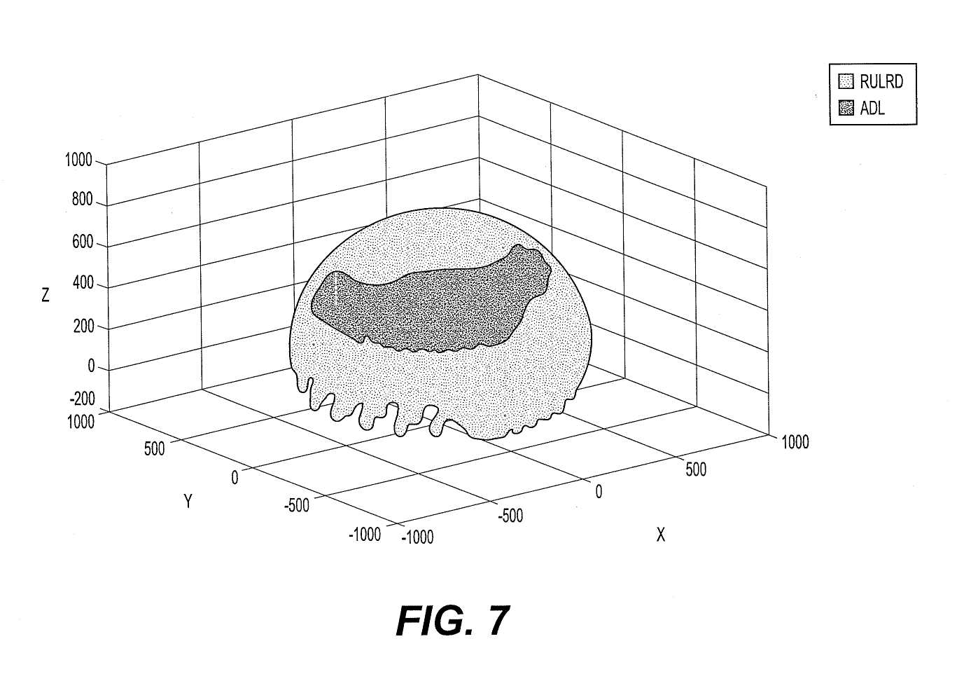

To graphically demonstrate the workspace of device 10 in its therapeutic mode (i.e., with the presence of the patient wearing the device), the motion of the device's end effector was recorded with the motion capture system when it was conforming to the motion of a healthy arm during ADL tasks. FIG. 7 compares the two workspaces, i.e., those of the ADL tasks and those of the robotic upper limb rehabilitation device (RULRD) 10.

Since the robotic upper limb rehabilitation device 10 is intended for training stroke patients for ADL tasks, the required torque values used for the design of the actuation system must be selected accordingly. The required force/torque calculations were performed for a worst case scenario to ensure that the device 10 is capable of supporting a large spectrum o f patients with different weights. Table 5 below shows the available force and torque at each actuated degree of freedom of the device.

TABLE 5
Force and Torque Requirements

| Actuator | 1 | 2 | 3 | 4 | 5 | 6 |
|---|---|---|---|---|---|---|
| Available | 53.3 | 58 | 31.9 | 31.9 | 31.9 | 21.44 |
| Unit | N · m | N | N · m | N · m | N · m | N · m |

It is to be understood that the robotic upper limb rehabilitation device is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A robotic upper limb rehabilitation device, comprising:
an articulated shoulder assembly;
an upper arm member pivotally attached to the shoulder assembly;
a forearm assembly pivotally attached to the upper arm member;
an inflatable hand grip pivotally attached to the forearm assembly;
a plurality of rotational actuators;
a linear actuator;
a plurality of sensors; and
a robotic control unit;
whereby the robotic control unit is configured for permitting the robotic upper limb rehabilitation device to conform to movement of a user's upper limb upon receiving signals from the plurality of sensors indicating normal movement of the user's upper limb, and being configured for activating the plurality of actuators to provide articulated movement of the robotic upper limb rehabilitation device to assist movement of the user's upper limb upon receiving signals from the sensors indicating impaired movement of the user's upper limb.

2. The robotic upper limb rehabilitation device as recited in claim 1, wherein the plurality of rotational actuators comprises first, second, third and fourth rotational actuators, and wherein the articulated shoulder assembly comprises:
a support member connected to the first rotational actuator by a prismatic joint, wherein the second rotational actuator is further connected to the support member, the support member extending between the second rotational actuator and the selectively adjustable prismatic joint;
a first arcuate shoulder member secured to, and extending between, the second and third rotational actuators; and
a second arcuate shoulder member secured to, and extending between, the third and fourth rotational actuators, wherein the fourth rotational actuator is coupled to the upper arm member.

3. The robotic upper limb rehabilitation device as recited in claim 2, wherein the plurality of rotational actuators further comprises a fifth rotational actuator, and wherein the forearm assembly comprises a forearm member connected to the fifth rotational actuator.

4. The robotic upper limb rehabilitation device as recited in claim 3, wherein the fifth rotational actuator is connected to the upper arm member by a selectively adjustable first linearly adjustable connector.

5. The robotic upper limb rehabilitation device as recited in claim 4, further comprising a forearm support connected to the forearm member by a selectively adjustable second linearly adjustable connector.

6. The robotic upper limb rehabilitation device as recited in claim 5, wherein the plurality of rotational actuators further comprises a pair of passive rotational joints, and wherein the inflatable hand grip is rotatively mounted on the pair of passive rotational joints, the pair of passive rotational joints being supported by the forearm support.

7. The robotic upper limb rehabilitation device as recited in claim 1, further comprising an upper arm brace secured to the upper arm member for releasably receiving an upper arm of the user.

8. The robotic upper limb rehabilitation device as recited in claim 1, further comprising a forearm brace secured to the selectively adjustable second linearly adjustable connector for releasably receiving a forearm of the user.

9. A robotic upper limb rehabilitation device, comprising:
an articulated shoulder assembly;
an upper arm member pivotally attached to the shoulder assembly;
a forearm assembly pivotally attached to the upper arm member;
a plurality of rotational actuators;
a linear actuator;
a plurality of sensors; and
a robotic control unit;
whereby the robotic control unit is configured for permitting the robotic upper limb rehabilitation device to conform to movement of a user's upper limb upon receiving signals from the plurality of sensors indicating normal movement of the user's upper limb, and being configured for activating the plurality of actuators to provide articulated movement of the robotic upper limb rehabilitation device to assist movement of the user's upper limb upon receiving signals from the sensors indicating impaired movement of the user's upper limb.

10. The robotic upper limb rehabilitation device as recited in claim 9, further comprising an inflatable hand grip pivotally attached to the forearm assembly.

11. The robotic upper limb rehabilitation device as recited in claim 10, wherein the plurality of rotational actuators comprises first, second, third and fourth rotational actuators, and wherein the articulated shoulder assembly comprises:
a support member connected to the first rotational actuator by a prismatic joint, wherein the second rotational actuator is further connected to the support member, the support member extending between the second rotational actuator and the selectively adjustable prismatic joint;
a first arcuate shoulder member secured to, and extending between, the second and third rotational actuators; and
a second arcuate shoulder member secured to, and extending between, the third and fourth rotational actuators, wherein the fourth rotational actuator is coupled to the upper arm member.

12. The robotic upper limb rehabilitation device as recited in claim 11, wherein the plurality of rotational actuators further comprises a fifth rotational actuator, and wherein the forearm assembly comprises a forearm member connected to the fifth rotational actuator.

13. The robotic upper limb rehabilitation device as recited in claim 12, wherein the fifth rotational actuator is connected to the upper arm member by a selectively adjustable first linearly adjustable connector.

14. The robotic upper limb rehabilitation device as recited in claim 13, further comprising a forearm support connected to the forearm member by a selectively adjustable second linearly adjustable connector.

15. The robotic upper limb rehabilitation device as recited in claim 14, wherein the plurality of rotational actuators further comprises a pair of passive rotational joints, and wherein the inflatable hand grip is rotatively mounted on the pair of passive rotational joints, the pair of passive rotational joints being supported by the forearm support.

16. The robotic upper limb rehabilitation device as recited in claim 10, further comprising an upper arm brace secured to the upper arm member for releasably receiving an upper arm of the user.

17. The robotic upper limb rehabilitation device as recited in claim 10, further comprising a forearm brace secured to the selectively adjustable second linearly adjustable connector for releasably receiving a forearm of the user.

18. A robotic upper limb rehabilitation device, comprising:
an articulated shoulder assembly;
an upper arm member pivotally attached to the shoulder assembly;
an upper arm brace for releasably receiving an upper arm of a user;
a forearm assembly pivotally attached to the upper arm member;
a forearm brace for releasably receiving a forearm of the user;
an inflatable hand grip extending from the forearm assembly;
a plurality of rotational actuators;
a linear actuator;
a plurality of sensors; and
a robotic control unit;
whereby the robotic control unit is configured for permitting the robotic upper limb rehabilitation device to conform to movement of an upper limb of the user upon receiving signals from the plurality of sensors indicating normal movement of the user's upper limb, and being configured for activating the plurality of actuators to provide articulated movement of the robotic upper limb rehabilitation device to assist movement of the user's upper limb upon receiving signals from the sensors indicating impaired movement of the user's upper limb.

19. The robotic upper limb rehabilitation device as recited in claim 18, wherein the plurality of rotational actuators comprises first, second, third and fourth rotational actuators, and wherein the articulated shoulder assembly comprises:
a support member connected to the first rotational actuator by a prismatic joint, wherein the second rotational actuator is further connected to the support member, the support member extending between the second rotational actuator and the selectively adjustable prismatic joint;
a first arcuate shoulder member secured to, and extending between, the second and third rotational actuators; and
a second arcuate shoulder member secured to, and extending between, the third and fourth rotational actuators, wherein the fourth rotational actuator is coupled to the upper arm member.

20. The robotic upper limb rehabilitation device as recited in claim 19, wherein the plurality of rotational actuators further comprises a fifth rotational actuator, and wherein the forearm assembly comprises a forearm member connected to the fifth rotational actuator, the fifth rotational actuator being connected to the upper arm member by a selectively adjustable first linearly adjustable connector.
